(19) United States
(12) Patent Application Publication
(10) Pub. No.: US 2012/0310577 A1
(43) Pub. Date: Dec. 6, 2012

(54) ELECTRONIC DEVICE AND METHOD FOR UPDATING COORDINATE SYSTEMS DURING EDITING OF A MEASUREMNT PROGRAM

(75) Inventors: CHIH-KUANG CHANG, Tu-Cheng (TW); XIN-YUAN WU, Shenzhen City (CN)

(73) Assignees: HON HAI PRECISION INDUSTRY CO., LTD., Tu-Cheng (TW); Hong Fu Jin Precision Industry (ShenZhen) Co., Ltd, Shenzhen City (CN)

(21) Appl. No.: 13/412,632

(22) Filed: Mar. 6, 2012

(30) Foreign Application Priority Data
May 31, 2011 (CN) 201110144658.6

(51) Int. Cl. G06F 19/00

(52) U.S. Cl. 702/94

(57) ABSTRACT

In a method for updating coordinate systems in editing a measurement program, the method imports a data array including measurement elements of a workpiece, and creates a program template. By inserting the program template in the data array that is after a measurement element, the method creates a coordinate system and calculates a coordinate matrix for the coordinate system. After the measurement elements in a position of the data array that are after the program template are updated using the coordinate matrix, a measurement program is generated and displayed on a display screen.

### BACKGROUND

1. Technical Field

Embodiments of the present disclosure generally relate to measurement program editing methods, and more particularly to an electronic device, a method, and a storage medium for updating electronic coordinate systems during editing of a measurement program.

2. Description of Related Art

Program editing greatly influences the speed of measuring a workpiece. Establishing a coordinate system is an important link in editing of a program. However, the establishment of a coordinate system has the following shortcomings: (1) different coordinate systems have different measurement elements, and each of the measurement elements is required to establish a corresponding coordinate system; (2) since the methods of establishing the coordinate systems may be similar, and many steps in the establishing process are the same, the same establishing steps would be performed many times. Since establishing a new coordinate system has the above shortcomings, the measurement speed is reduced. Therefore, an improved method is desirable to address the aforementioned issues.

### BRIEF DESCRIPTION OF THE DRAWINGS

FIG. 1 is a block diagram of one embodiment of an electronic device including a coordinate system updating unit.

FIG. 2 is a flowchart illustrating one embodiment of a method for updating electronic coordinate systems during editing a measurement program using the electronic device of FIG. 1.

FIG. 3 illustrates an example of establishing a coordinate system according to a program template.

FIG. 4 is a detailed description of block S16 in FIG. 2, for calculating a coordinate matrix of a coordinate system.

FIG. 5 illustrates a coordinate system before and after correction of the coordinate system.

FIG. 6 illustrates a coordinate system before and after rotation of the coordinate system.

FIG. 7 illustrates a coordinate system before and after adjustment of point zero for the coordinate system.

FIG. 8 is a detailed description of block S18 in FIG. 2, for generating a measurement program.

### DETAILED DESCRIPTION

In general, the term “module,” as used herein, refers to logic embodied in hardware or firmware, or to a collection of software instructions, written in a programming language, such as, for example, Java, C, or assembly. One or more software instructions in the modules may be embedded in firmware, such as in an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable medium or computer storage device.

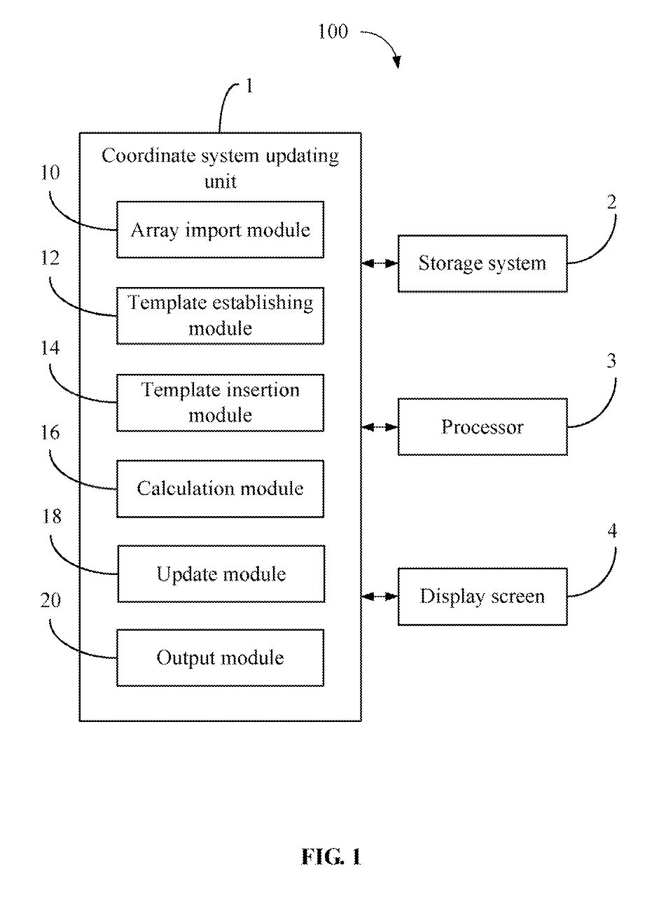

FIG. 1 is a block diagram of one embodiment of an electronic device 100 including a coordinate system updating unit 1. The electronic device 100 further includes a storage system 2, at least one processor 3, and a display screen 4. In one embodiment, the electronic device 1 may be a computer, a server, a portable electronic device, or any other electronic device. Functions of the updating unit 1 are implemented by the electronic device 100. The updating unit 1 may be a software program stored in the storage system 2 and executed by the processor 3. The display screen 4 displays a measurement program.

In one embodiment, the storage system 2 may be a magnetic or an optical storage system, such as a hard disk drive, an optical drive, a compact disc, a digital video disc, a tape drive, or other suitable storage medium. The processor 3 may be a central processing unit including a math co-processor, for example.

In one embodiment, the updating unit 1 includes an array import module 10, a template establishing module 12, a template insertion module 14, a calculation module 16, an update module 18, and an output module 20. Each of the modules 10-20 may be a software program including one or more computerized instructions that are stored in the storage system 2 and executed by the processor 3.

The array import module 10 imports a data array of a workpiece from the storage system 2. The data array includes one or more measurements of the workpiece (“measurement elements”) that are used to establish one or more electronic coordinate systems. In the embodiment, each workpiece corresponds to one data array. The data array is a data structure consisting of measurement data of each of the measurement elements. The measurement data is composed by character strings, which are a collection of values or variables and are identified by at least one array index or keyword. In one embodiment, the workpiece is an object to be measured, which is composed by the one or more measurement elements.

For example, a data array in this embodiment may be described as follows:

### S1=FEAT/PLANE

PTMEAS/CART,2.193,3.101,1.000,0.0000,0.0000,1.0000

PTMEAS/CART,2.020,0.937,1.000,0.0000,0.0000,1.0000

PTMEAS/CART,3.716,1.155,1.000,0.0000,0.0000,1.0000

PTMEAS/CART,4.554,3.157,1.000,0.0000,0.0000,1.0000

ENDMES;

### S2=FEAT/LINE

PTMEAS/CART,0.268,0.000,0.904,0.0000,−1.0000,0.0000

PTMEAS/CART,5.285,−0.000,0.864,0.0000,−1.0000,0.0000

ENDMES;

### S3=FEAT/POINT

PTMEAS/CART,0.000,0.209,0.903,−1.0000,0.0000,0.0000

ENDMES;

### S4=FEAT/POINT

PTMEAS/CART,6.486,0.000,0.897,0.0000,−1.0000,0.0000

ENDMES;

### S5=FEAT/POINT

PTMEAS/CART,6.900,0.143,0.905,1.0000,−0.0000,0.0000

ENDMES;

### S6=FEAT/POINT

PTMEAS/CART,6.900,1.907,0.885,1.0000,0.0000,0.0000

ENDMES;

### S7=FEAT/POINT

PTMEAS/CART,6.900,2.709,0.885,1.0000,0.0000,0.0000

ENDMES;

### S8=FEAT/LINE

PTMEAS/CART,6.416,4.600,0.898,0.0000,1.0000,0.0000

PTMEAS/CART,3.905,4.600,0.833,0.0000,1.0000,0.0000

ENDMES;

### S9=FEAT/CIRCLE

PTMEAS/CART,3.072,2.562,0.966,0.8159,−0.5782,0.0000

PTMEAS/CART,3.659,2.710,0.941,−0.4601,−0.8878,−0.0000

PTMEAS/CART,3.908,2.276,0.975,−0.9979,0.0641,0.0000

ENDMES.

As described above, the data array includes the measurement elements “S1,” “S2,” “S3,” “S4,” “S5,” “S6,” “S7,” “S8,” and “S9.” The measurement element “S1” represents a plane, the measurement elements “S2” and “S8” represent lines, the measurement elements “S3” and “S7” represent points, and the measurement element “S9” represents a circle. The numerics in each measurement element represent measurement data of the corresponding measurement element. For example, the numerics “3.908,2.276,0.975,−0.9979,0.0641,0.0000” in the measurement element “S9” are the measurement data of the circle. That is, the data array includes the measurement data of the plane, the lines, the points, and the circle.

Different electronic coordinate systems are established by different steps (“establishing steps”). In an example, one of the electronic coordinate systems are established by three steps: establishing a reference plane; establishing three reference axes including x, y, and z reference axes; and establishing a reference origin point. The other electronic coordinate systems are established by one step, namely, establishing a reference origin point. Before establishing the one or more electronic coordinate systems, the template establishing module 12 classifies the one or more electronic coordinate systems into at least one particular type according to the establishing steps. Supposing that three electronic coordinate systems are required to establish, and the three electronic coordinate systems may be classified into two types: a first type and a second type. The first type of coordinate system is established by the three establishing steps, and the second type of coordinate system is established by the one step.

For example, the measurement elements “S1,” “S2,” and “S3” can be used for establishing a first coordinate system of the first type. The measurement element “S6” may be used for establishing a second coordinate system of the second type. The measurement element “S9” may be used for establishing a third coordinate system of the second type. In an example, supposing that the first coordinate system is established by the immediately following steps: correcting the reference plane of the measurement element “S1”; performing zero returning of a point of origin of the Z reference axis of the measurement element “S1”; correcting the X reference axis of the measurement element “S2”; performing zero returning of a point of origin of the Y reference axis of the measurement element “S2”; and performing zero returning of a point of origin of the X reference axis of the measurement element “S3.” In an example, supposing that the second coordinate system is established by the immediately following steps: performing zero returning of a point of origin of the Z reference axis of the measurement element “S6” or “S9”; performing zero returning of a point of origin of the Y reference axis of the measurement elements “S6” or “S9”; and performing zero returning of a point of origin of the X reference axis.

In the embodiment, the template establishing module 12 further creates a program template for establishing each type of electronic coordinate system. In one embodiment, the program template may be described as follows:

### WCS1=ALIGNMENT/START,RECALL: WCS

LEVEL,ZPLUS,#Format0

TRANS,ZPLUS,#Format1

ROTATE,XPLUS,TO,#Format2,ABOUT,ZPLUS

TRANS,YPLUS,#Format3

TRANS,XPLUS,#Format4

ENDALIGNMEN.

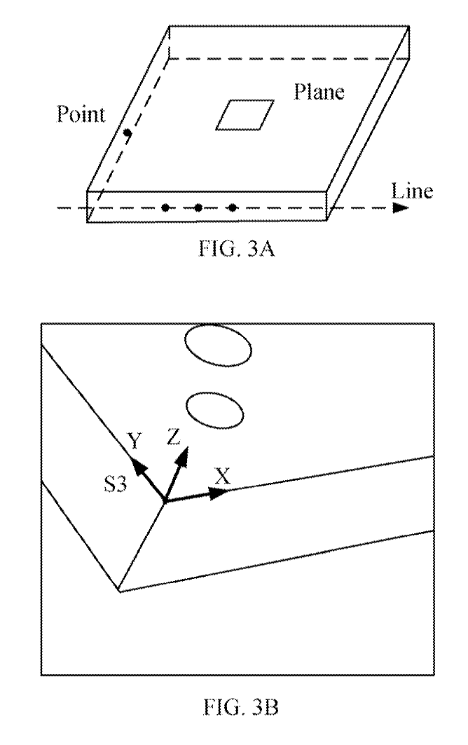

In the program template, “#Format0,” “#Format1,” “#Format2,” “#Format3” and “#Format4” are keywords, which can be replaced by the measurement elements described below. The program template also can be illustrated by a graphic, such as shown in part (A) of FIG. 3.

The template insertion module 14 inserts the program template in a position of the data array that is after a position of a measurement element in the data array. For example, the template insertion module 14 inserts the program template “WCS1” described above into a position of the data array that is after the measurement element “S3.”

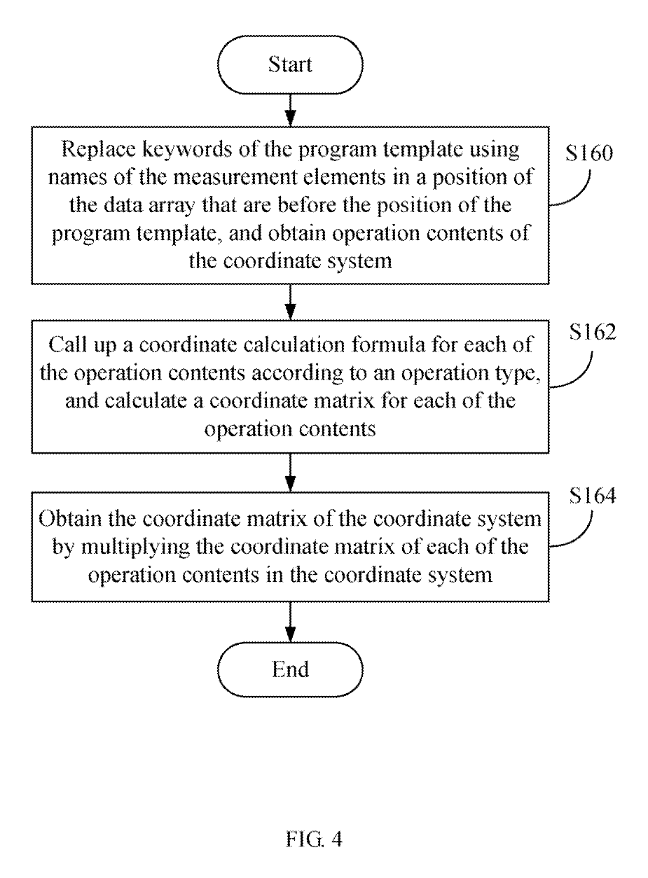

The calculation module 16 creates an electronic coordinate system based on the program template and the measurement elements in a position of the data array that are before a position of the program template in the data array, and calculates a coordinate matrix for the electronic coordinate system. For example, the calculation module 16 replaces the point, plane and line of the part (A) (namely keywords of the program template) of FIG. 3 by the measurement elements “S1,” “S2” and “S3” according to the steps for establishing the first coordinate system, and then the first coordinate system can be created and shown in part (B) of FIG. 3. Details of how to calculate the coordinate matrix of the coordinate system are described in FIG. 4.

The update module 18 generates a measurement program by updating the measurement elements in the data array that are after the position of the program template in the data array using the coordinate matrix. In detail, the update module 18 uses the coordinate matrix to calculate the coordinate values of the measurement elements in a position of the data array that are after the program template, and updates the measurement elements in the position of the data array that are after the program template with the newly-calculated coordinate values.

The output module 20 outputs the measurement program and displays the measurement program on the display screen 4.

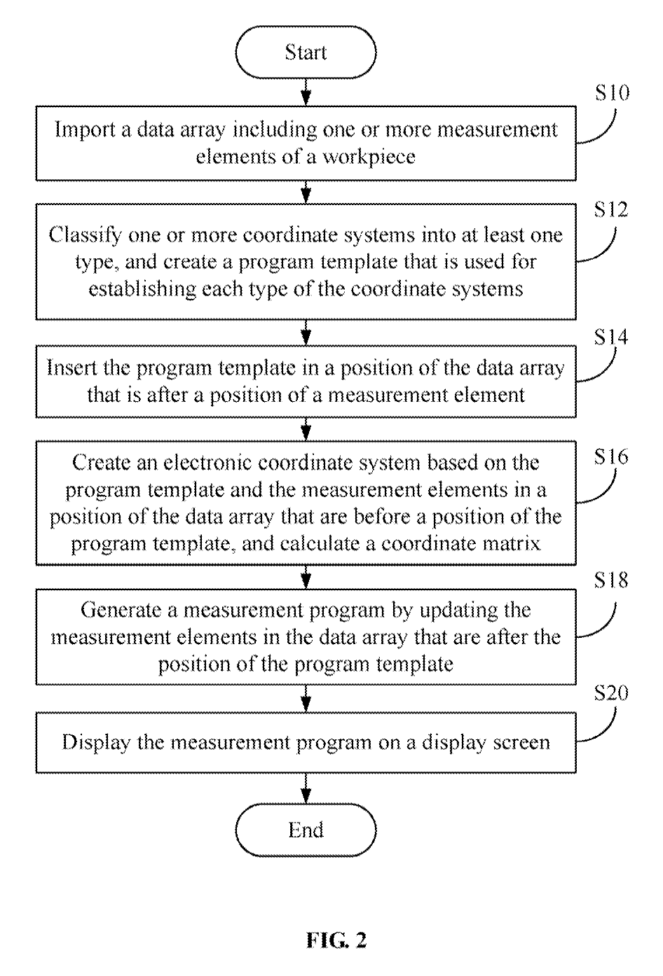

FIG. 2 is a flowchart illustrating one embodiment of a method for updating electronic coordinate systems during editing a measurement program using the electronic device of FIG. 1. The method can be performed by a computer-readable program being executed by the at least one processor 3. Depending on the embodiment, in FIG. 2, additional blocks may be added, others removed, and the ordering of the blocks may be changed.

In step S10, the array import module 10 imports a data array including one or more measurement elements of a workpiece from the storage system 2. In the embodiment, each workpiece corresponds to one data array. As described above, the data array includes measurement data of each of the measurement elements, such as planes, lines, points and circles of the workpiece. The one or more measurement elements are required to establish one or more electronic coordinate systems, such as three electronic coordinate systems, for example. Different electronic coordinate systems are established by different steps (“establishing steps”).

In step S12, the template establishing module 12 classifies the one or more electronic coordinate systems into at least one of particular types according to the establishing steps. And then, the template establishing module 12 creates a program template for establishing each type of the electronic coordinate systems.

In step S14, the template insertion module 14 inserts the program template in a position of the data array that is after a position of a measurement element in the data array, such as the measurement element “S3,” for example.

In step S16, the calculation module 16 creates an electronic coordinate system based on the program template and the measurement elements in a position of the data array that are before a position of the program template in the data array, and calculates a coordinate matrix for the electronic coordinate system. For example, if the template insertion module 14 inserts the program template in a position of the data array that is after the measurement element “S3,” the calculation module 16 creates the coordinate system based on the program template and the measurement elements “S1,” “S2” and “S3”. Details of calculating the coordinate matrix of the coordinate system are described in FIG. 4.

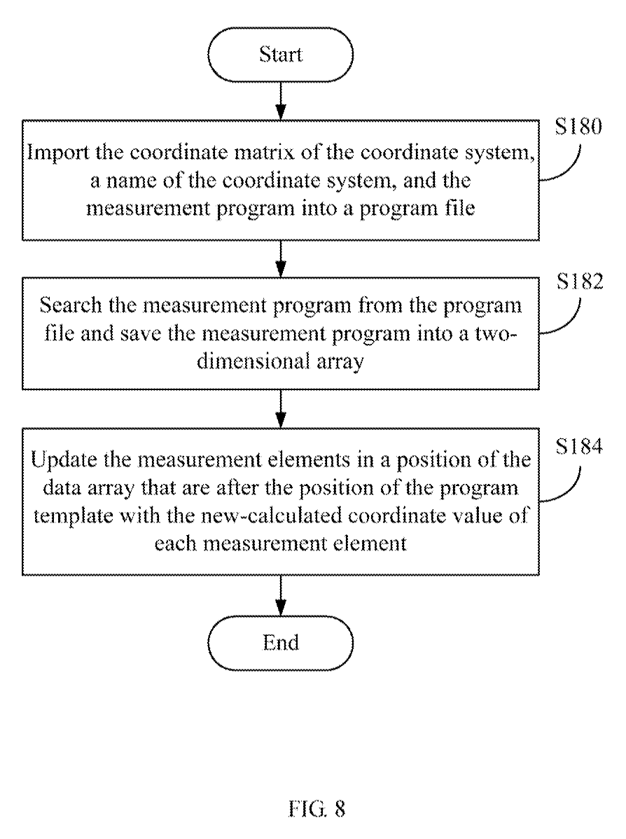

In step S18, the update module 18 generates a measurement program by updating the measurement elements in the data array that are after the position of the program template in the data array using the coordinate matrix. For example, if the template insertion module 14 inserts the program template in the data array that are after the position of the measurement element “S3,” the update module 18 updates the measurement element “S4” using the coordinate matrix. Details of generating the measurement program are described in FIG. 8.

In step S20, the output module 20 outputs the measurement program and displays the measurement program on the display screen 4.

FIG. 4 is a detailed description of block S16 in FIG. 2, for calculating a coordinate matrix of a coordinate system.

In step S160, the calculation module 16 replaces keywords of the program template using names of the measurement elements in a position of the data array that are before the position of the program template and obtaining operation contents of the coordinate system.

For example, if the establishment of a first coordinate system is required, the calculating module 16 replaces the keywords “#Format0,” “#Format1,” “#Format2,” “#Format3” and “#Format4” in the program template “WCS1” by the measurement elements “S1,” “S2” and “S3” according to the establishing steps, and then the names of the measurement elements “S1,” “S2” and “S3” are inserted into the program template as follows:

### WCS1=ALIGNMENT/START,RECALL: WCS

LEVEL,ZPLUS,S1

TRANS,ZPLUS,S1

ROTATE,XPLUS,TO,S2,ABOUT,ZPLUS

TRANS,YPLUS,S2

TRANS,XPLUS,S3

ENDALIGNMEN.

Measurement elements “S1,” “S2” and “S3” are inserted in a position of the data array that are after the position of the measurement elements “S3”. The coordinate system is shown in the part (B) of FIG. 3.

In step S162, the calculation module 16 calls up a coordinate calculation formula for each of the operation contents according to an operation type, and calculates a coordinate matrix for each of the operation contents. In the embodiment, the operation type includes: establishing the reference plane, establishing the reference axes and establishing the reference origin point. The coordinate calculation formula includes a first formula for calculating and correcting planes of the coordinate system (Level), a second formula for calculating a rotation angle of the coordinate system (Rotate), and a third formula for calculating a distance for zero returning of a point of origin of the coordinate system (Transfer).

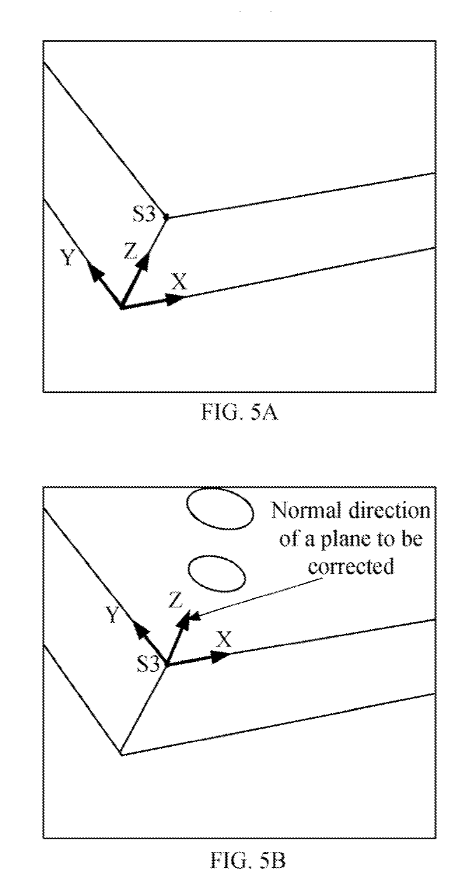

FIG. 5 illustrates a coordinate system before and after correction. Part (C) illustrates the coordinate system before the correction, and part (D) illustrates the coordinate system after the correction. The coordinate system is corrected by rotating the coordinate system for a first angle along a first rotation axis. In the embodiment, the first rotation axis is obtained by multiplying a normal vector of a plane of the coordinate system under correction with a vector of a target axis of the coordinate system. The first angle is equal to an angle between the normal axis of the plane under correction and the target axis of the coordinate system.

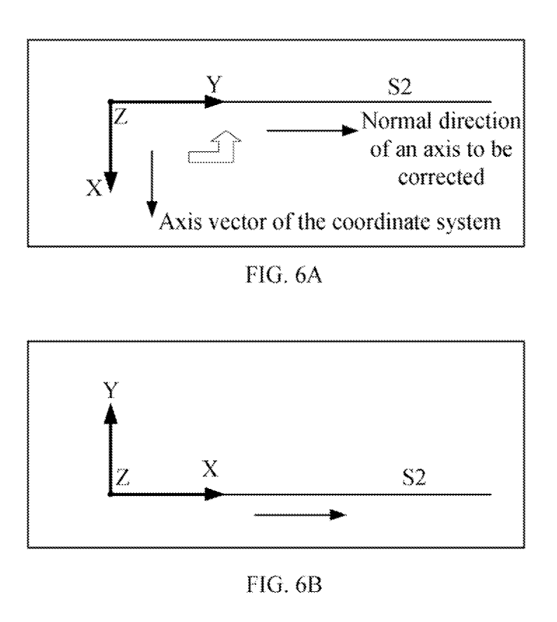

FIG. 6 illustrates a coordinate system before and after rotation. Part (E) illustrates the coordinate system before the rotation, and part (F) illustrates the coordinate system after the rotation. The coordinate system in part (F) is obtained by rotating the coordinate system in part (E) for a second angle along a second rotation axis. In the embodiment, the second rotation axis is obtained by projecting, from the original coordinate system, a normal vector of an axis and an axis vector to a plane for locating the coordinate system, and by multiplying the normal vector of the axis and the axis vector on the plane. The second angle is an angle found between the normal vector of the axis projected on the plane and the axis vector of the coordinate system projected on the plane.

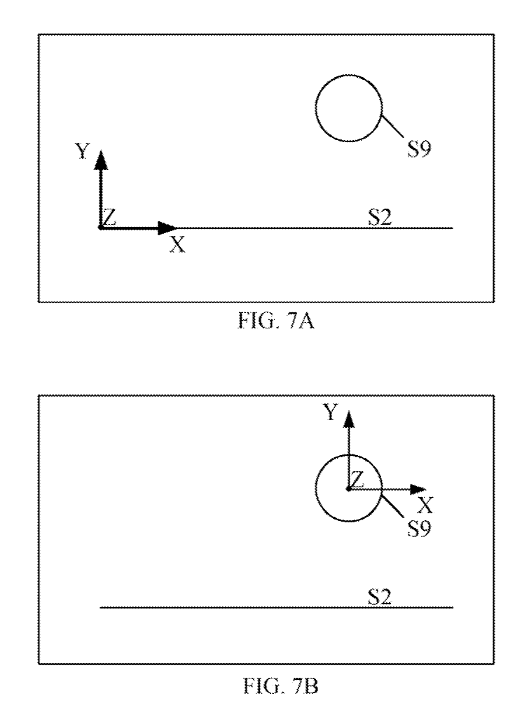

FIG. 7 illustrates a coordinate system before and after zero returning for the coordinate system. In part (G), the origin point of the coordinate system before zero returning is along the measurement element “S2,” the origin point of the coordinate system after zero returning is a center of the measurement element “S9” shown in part (H). The formula for calculating a distance for zero returning of the origin point of the coordinate system is as follows:

$$[ \begin{matrix}1 & 0 & 0 & {T}_{x} \\ 0 & 1 & 0 & {T}_{y} \\ 0 & 0 & 1 & {T}_{z} \\ 0 & 0 & 0 & 1\end{matrix} ] .$$

The values of Tx, Ty and Tz are coordinate values of the center of the measurement element “S9.”

In step S164, the calculation module 16 multiplies the coordinate matrix of each step in the coordinate system to obtain the new coordinate matrix of the coordinate system.

FIG. 8 is a detailed description of block S18 in FIG. 2, for generating a measurement program.

In block S180, the update module 18 imports the coordinate matrix of the original coordinate system, a name (such as “WCS1”) of that coordinate system, and the measurement program into a program file.

In block S182, the update module 18 searches the measurement program from the program file according to the coordinate matrix and the name of the coordinate system, and saves the measurement program into a two-dimensional array. In the embodiment, the two-dimensional array is composed of a name and contents of the program of each of the measurement elements and the electronic coordinate systems included in the measurement program.

In block S184, the update module 18 reads an original coordinate value and a vector of each measurement element after the coordinate system, and updates the original coordinate value of each measurement element with a new-calculated coordinate value by multiplying the original coordinate value and the vector with the coordinate matrix of the coordinate system. The update module 18 updates the measurement elements in a position of the data array that are after the program template with the new-calculated coordinate value of each measurement element.

For example, the coordinate system may be inserted after the measurement element “S3” as follows:

### S1=FEAT/PLANE

PTMEAS/CART,2.193,3.101,1.000,0.0000,0.0000,1.0000

PTMEAS/CART,2.020,0.937,1.000,0.0000,0.0000,1.0000

PTMEAS/CART,3.716,1.155,1.000,0.0000,0.0000,1.0000

PTMEAS/CART,4.554,3.157,1.000,0.0000,0.0000,1.0000

ENDMES;

### S2=FEAT/LINE

PTMEAS/CART,0.268,0.000,0.904,0.0000,−1.0000,0.0000

PTMEAS/CART,5.285,−0.000,0.864,0.0000,−1.0000,0.0000

ENDMES;

### S3=FEAT/POINT

PTMEAS/CART,0.000,0.209,0.903,−1.0000,0.0000,0.0000

ENDMES;

### WCS1=ALIGNMENT/START,RECALL: WCS

LEVEL,ZPLUS,S1

TRANS,ZPLUS,S1

ROTATE,XPLUS,TO,S2,ABOUT,ZPLUS

TRANS,YPLUS,S2

TRANS,XPLUS,S3

ENDALIGNMEN;

### S4=FEAT/POINT

PTMEAS/CART,6.486,0.000,0.897,0.0000,−1.0000,0.0000

ENDMES.

After updating the measurement elements in a position of the data array that are after the position of the program template, the update module 18 generates a measurement program as follows:

### S1=FEAT/PLANE

PTMEAS/CART,2.193,3.101,1.000,0.0000,0.0000,1.0000

TMEAS/CART,2.020,0.937,1.000,0.0000,0.0000,1.0000

PTMEAS/CART,3.716,1.155,1.000,0.0000,0.0000,1.0000

PTMEAS/CART,4.554,3.157,1.000,0.0000,0.0000,1.0000

ENDMES;

### S2=FEAT/LINE

PTMEAS/CART,0.268,0.000,0.904,0.0000,−1.0000,0.0000

PTMEAS/CART,5.285,−0.000,0.864,0.0000,−1.0000,0.0000

ENDMES;

### S3=FEAT/POINT

PTMEAS/CART,0.000,0.209,0.903,−1.0000,0.0000,0.0000

ENDMES;

### WCS1=ALIGNMENT/START,RECALL: WCS

LEVEL,ZPLUS,S1

TRANS,ZPLUS,S1

ROTATE,XPLUS,TO,S2,ABOUT,ZPLUS

TRANS,YPLUS,S2

TRANS,XPLUS,S3

ENDALIGNMEN;

### S4=FEAT/POINT

PTMEAS/CART,10,0.000,0,1.0000,0.0000,0.0000

### ENDMES.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-implemented method using an electronic device, the method comprising:
(a) importing a data array comprising one or more measurement elements of a workpiece;
(b) inserting a program template in a position of the data array that is after a position of a measurement element in the data array;
(c) creating an electronic coordinate system based on the program template and the measurement elements in a position of the data array that are before a position of the program template in the data array, and calculating a coordinate matrix for the electronic coordinate system;
(d) generating a measurement program by updating the measurement elements in the data array that are after the position of the program template in the data array using the coordinate matrix; and
(e) displaying the measurement program on a display screen of the electronic device.

2. The method as described in claim 1, wherein the block (c) comprises:
replacing keywords of the program template using names of the measurement elements in a position of the data array that are before the position of the program template and obtaining operation contents of the coordinate system;
calculating a coordinate matrix for each of the operation contents according to a coordinate calculation formula; and
obtaining the coordinate matrix of the coordinate system by multiplying the coordinate matrix of each of the operation contents in the coordinate system.

3. The method as described in claim 1, wherein the coordinate calculation formula comprises a first formula for calculating and correcting planes of the coordinate system, a second formula for calculating a rotation angle of the coordinate system, and a third formula for calculating a distance for zero returning of an origin point of the coordinate system.

4. The method as described in claim 1, wherein the block (d) comprises:
importing the coordinate matrix of the coordinate system, a name of the coordinate system, and the measurement program into a program file;
searching the measurement program according to the coordinate matrix and the name of the coordinate system, and saving the measurement program into a two-dimensional array;
reading an original coordinate value and a vector of each measurement element after the coordinate system, and updating the original coordinate value of each measurement element with a new-calculated coordinate value by multiplying the original coordinate value and the vector with the coordinate matrix of the coordinate system; and
updating the measurement elements in a position of the data array that are after the position of the program template with the new-calculated coordinate value of each measurement element.

5. An electronic device, comprising:
at least one processor;
a storage system; and
one or more modules that are stored in the storage system and executed by the at least one processor, the one or more modules comprising:
an array import module that imports a data array comprising one or more measurement elements of a workpiece;
a template insertion module that inserts a program template in a position of the data array that is after a position of a measurement element in the data array;
a calculation module that creates an electronic coordinate system based on the program template and the measurement elements in a position of the data array that are before a position of the program template in the data array, and calculates a coordinate matrix for the electronic coordinate system;
an update module that generates a measurement program by updating the measurement elements in the data array that are after the position of the program template in the data array using the coordinate matrix; and
an output module that displays the measurement program on a display screen of the electronic device.

6. The electronic device as described in claim 5, wherein the calculation module calculates the coordinate matrix of the coordinate system by executing following steps:
replacing keywords of the program template using names of the measurement elements in a position of the data array that are before the position of the program template and obtaining operation contents of the coordinate system;
calculating a coordinate matrix for each of the operation contents according to a coordinate calculation formula; and
obtaining the coordinate matrix of the coordinate system by multiplying the coordinate matrix of each of the operation contents in the coordinate system.

7. The electronic device as described in claim 5, wherein the coordinate calculation formula comprises a first formula for calculating and correcting planes of the coordinate system, a second formula for calculating a rotation angle of the coordinate system, and a third formula for calculating a distance for zero returning of an origin point of the coordinate system.

8. The electronic device as described in claim 5, wherein the update module generates the measurement program by executing following steps:
importing the coordinate matrix of the coordinate system, a name of the coordinate system, and the measurement program into a program file;
searching the measurement program according to the coordinate matrix and the name of the coordinate system, and saving the measurement program into a two-dimensional array;
reading an original coordinate value and a vector of each measurement element after the coordinate system, and updating the original coordinate value of each measurement element with a new-calculated coordinate value by multiplying the original coordinate value and the vector with the coordinate matrix of the coordinate system; and
updating the measurement elements in a position of the data array that are after the position of the program template with the new-calculated coordinate value of each measurement element.

9. A non-transitory storage medium having stored thereon instructions that, when executed by a processor of an electronic device, causes the electronic device to perform a method for updating coordinate systems during editing a measurement program, the method comprising:
(a) importing a data array comprising one or more measurement elements of a workpiece;
(b) inserting a program template in a position of the data array that is after a position of a measurement element in the data array;
(c) creating an electronic coordinate system based on the program template and the measurement elements in a position of the data array that are before a position of the program template in the data array, and calculating a coordinate matrix for the electronic coordinate system;
(d) generating a measurement program by updating the measurement elements in the data array that are after the position of the program template in the data array using the coordinate matrix; and
(e) displaying the measurement program on a display screen of the electronic device.

10. The non-transitory storage medium as described in claim 9, wherein the step (d) comprises:
replacing keywords of the program template using names of the measurement elements in a position of the data array that are before the position of the program template and obtaining operation contents of the coordinate system;
calculating a coordinate matrix for each of the operation contents according to a coordinate calculation formula; and
obtaining the coordinate matrix of the coordinate system by multiplying the coordinate matrix of each of the operation contents in the coordinate system.

11. The non-transitory storage medium as described in claim 9, wherein the coordinate calculation formula comprises a first formula for calculating and correcting planes of the coordinate system, a second formula for calculating a rotation angle of the coordinate system, and a third formula for calculating a distance for zero returning of an origin point of the coordinate system.

12. The non-transitory storage medium as described in claim 9, wherein the step (e) comprises:
importing the coordinate matrix of the coordinate system, a name of the coordinate system, and the measurement program into a program file;
searching the measurement program according to the coordinate matrix and the name of the coordinate system, and saving the measurement program into a two-dimensional array;
reading an original coordinate value and a vector of each measurement element after the coordinate system, and updating the original coordinate value of each measurement element with a new-calculated coordinate value by multiplying the original coordinate value and the vector with the coordinate matrix of the coordinate system; and
updating the measurement elements in a position of the data array that are after the position of the program template with the new-calculated coordinate value of each measurement element.
